(19) United States
(12) Patent Application Publication
(10) Pub. No.: US 2025/0292332 A1
(43) Pub. Date: Sep. 18, 2025

(54) VEHICLE INSURANCE PREMIUM CALCULATION DEVICE

(71) Applicant: TOYOTA JIDOSHA KABUSHIKI KAISHA, Aichi-ken (JP)

(72) Inventors: Eiji NISHIKAWA, Toyota-shi (JP); Kyohei KAMIJUKKOKU, Toyota-shi (JP); Takayuki NAKANO, Nisshin-shi (JP)

(21) Appl. No.: 19/075,787

(22) Filed: Mar. 11, 2025

(30) Foreign Application Priority Data
Mar. 15, 2024 (JP) 2024-040657

(51) Int. Cl. G06Q 40/08; G06T 7/00

(52) U.S. Cl. CPC G06Q 40/08; G06T 7/0008; G06T 2207/30252

(57) ABSTRACT

The processor of the calculation device is configured to perform a determination process and a calculation process. In the determination process, the processor determines the presence or absence of a protective component for covering at least one panel disposed on a top of a vehicle. In the calculation process, the processor calculates, when at least one of panels disposed on the top of the vehicle is covered by the protective component, a smaller insurance premium than an insurance premium calculated when none of the panels disposed on the top of the vehicle is covered by the protective component.

### CROSS REFERENCE TO RELATED APPLICATION

This application claims priority to Japanese Patent Application No. 2024-040657, filed on Mar. 15, 2024, which is incorporated herein by reference in its entirety including the specification, claims, drawings, and abstract.

### TECHNICAL FIELD

The present specification discloses a vehicle insurance premium calculation device.

### BACKGROUND

JP-A-2019-529241, JP-A-2023-518289, and JP-U-3111152 disclose a protective cover for covering a vehicle. By covering the vehicle with the cover, damage to the vehicle top at the time of hailing can be suppressed.

When a vehicle to be insured is damaged by a natural disaster such as hail damage, an insurance company may incur a repair cost. Therefore, in the present specification, a vehicle insurance premium calculation device capable of reducing the burden of repair cost by an insurance company at the time of hail damage is disclosed.

### SUMMARY

The present specification discloses a vehicle insurance premium calculation device. This device comprises a processor. The processor is configured to perform a determination process and a calculation process. In the determination process, the processor determines the presence or absence of a protective component for covering at least one panel disposed on a top of a vehicle. In the calculation process, the processor calculates, when at least one of panels disposed on the top of the vehicle is covered by the protective component, a smaller insurance premium than an insurance premium calculated when none of the panels disposed on the top of the vehicle is covered by the protective component.

With the above-described configuration, by providing the premium discount service, an incentive to cover the panels disposed on the top of the vehicle with a protective component is obtained.

Further, in the above-described determining process, the processor may determine whether the at least one of panels that is covered by the protective component is contained in a panel group consisting of a plurality of panels welded to a framework component of the vehicle. In the calculation process, the processor may calculate a first insurance premium when the at least one of the panels that is covered by the protective component is contained in the panel group, and calculate a second insurance premium when the at least one of panels that is covered by the protective component is not contained in the panel group, the first insurance premium being lower than the second insurance premium.

By replacing the panel members included in the panel group, a so-called repair history may be given to the vehicle. The vehicle to which the repair history is given has a lower market value. By adopting the fee system having the above-described configuration, it is possible to suppress a decrease in market value of the vehicle.

Further, in the above-described calculation process, the processor may calculate a discount on the first insurance premium, based on a cover ratio being the ratio of an area, in a plan view, of the protective component relative to the sum of areas, in the plan view, of all of the plurality of panels in the panel group.

With the above-described configuration, an incentive to increase the protection area of the panels included in the panel group is obtained.

Further, in the above-described configuration, a protection film may be attached as the protective component onto the at least one of panels. When the protection film comprises two or more overlapped protection films, the processor calculates, in the calculation process, the discount on the first insurance premium, based on the number of the overlapped protection films.

As the number of the overlapped protection films increases, damage to the panels decreases. With the above-described configuration, an incentive to increase the number of overlapped protection films with respect to the panels included in the panel group is obtained.

According to the vehicle insurance premium calculation device disclosed in the present specification, it is possible to reduce the burden of repair cost by an insurance company during hail damage.

### BRIEF DESCRIPTION OF DRAWINGS

Embodiments of the present disclosure will be described based on the following figures, wherein:

FIG. 1 is a plan view of a vehicle showing an example in which a protection film is attached to a hood panel;

FIG. 2 is a plan view of a vehicle showing an example in which a roof carrier is attached to a roof panel;

FIG. 3 is a diagram illustrating a flow of a vehicle lease contract including a film application;

FIG. 4 is a diagram illustrating a flow of a vehicle lease contract including a carrier attachment subscription;

FIG. 5 is a diagram illustrating a hardware configuration of the vehicle insurance premium calculation device according to the present embodiment;

FIG. 6 is a diagram illustrating an insurance contract table stored in the vehicle insurance premium calculation device;

FIG. 7 is a diagram illustrating an insurance premium calculation flow executed by the processor of the calculation device;

FIG. 8 is a plan view of a vehicle showing an example in which two protection films are overlapped on a roof panel;

FIG. 9 is a plan view of the vehicle for explaining how the protection film is attached (using a recess);

FIG. 10 is a plan view of the vehicle for explaining how the protection film is attached (an antenna alignment);

FIG. 11 is a diagram illustrating a flow of an automobile insurance contract including application of film attachment; and

FIG. 12 is a diagram illustrating a flow of an automobile insurance contract including application of carrier attachment.

### DESCRIPTION OF EMBODIMENTS

### 1. Vehicle Structure

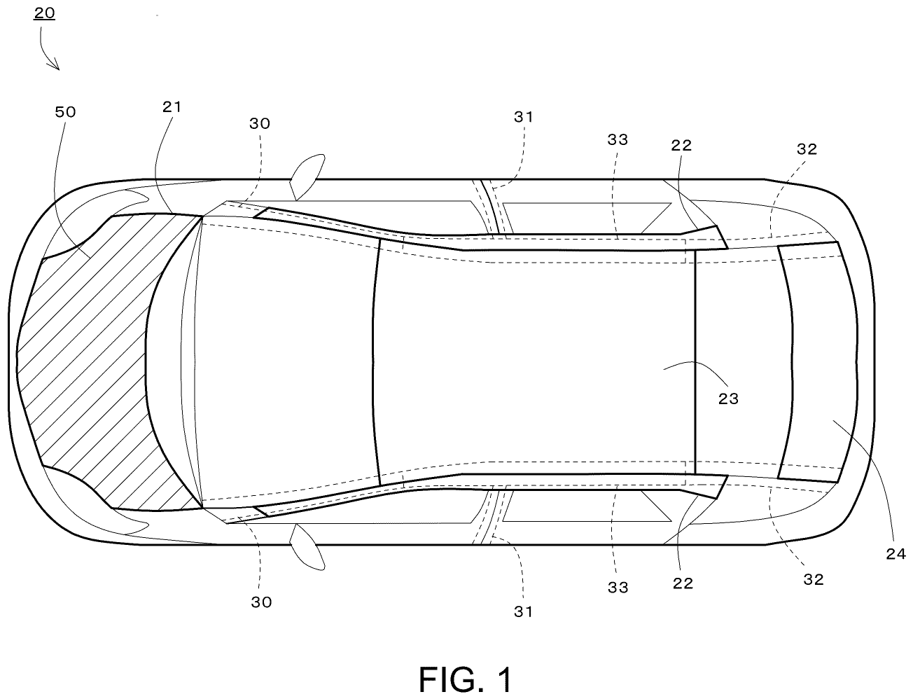

FIG. 1 illustrates a plan view of a vehicle 20. A plurality of panel members are disposed on the top of the vehicle 20. Specifically, a hood panel 21, a roof side panel 22, a roof panel 23, and a back door panel 24 are disposed on a top of the vehicle 20. These panel members are exposed to the outside on the top of the vehicle 20. Accordingly, hail hits these panels during hailing.

The hood panel 21 covers the engine compartment. For example, the rear end portion of the hood panel 21 in the vehicle longitudinal direction is connected to a hinge mechanism (not shown). The back door panel 24 is disposed at the rear end of the vehicle. The back door panel 24 constitutes a part of an exposed surface of the back door.

The roof panel 23 is a panel member that covers the top of the vehicle cabin. For example, among the panels covering the top of the vehicle 20, the roof panel 23 has the largest area. Further, roof side panels 22 are disposed at both ends of the roof panel 23 in the vehicle width direction.

The vehicle 20 includes a plurality of skeleton parts. The skeleton part includes an A pillar 30, a B pillar 31, a C pillar 32, and a roof side rail 33. The A pillar 30 is a pillar component disposed in front of the vehicle cabin. The C-pillar 32 is a pillar component disposed behind the vehicle cabin. A roof side rail 33 is connected to the rear end of the A pillar 30 and the front end of the C pillar 32. Further, the B pillar 31 extends downward from the intermediate portion of the roof side rail 33.

Both ends of the roof panel 23 on the outer side in the vehicle width direction are welded and fixed to the A pillar 30, the roof side rail 33, and the C pillar 32. An inner end portion of the roof side panel 22 in the vehicle width direction is also welded and fixed to the A pillar 30, the roof side rail 33, and the C pillar 32.

Since the roof panel 23 and the roof side panel 22 are welded to the framework component of the vehicle 20, the roof panel 23 and the roof side panel 22 may be determined to be part of the vehicle framework. Therefore, when the roof panel 23 and the roof side panel 22 are replaced, it is determined that a part of the vehicle skeleton is changed. As a result, a so-called repair history is given to the vehicle 20. The market value of the vehicle 20 to which the repair history is given decreases.

As will be described later, in the vehicle insurance premium calculation device according to the present embodiment, when the panels are covered with the protective component, the insurance premium is calculated at a lower price than when the panels are not covered with the protective component. Further, the insurance premium varies depending on the object covered by the protective component.

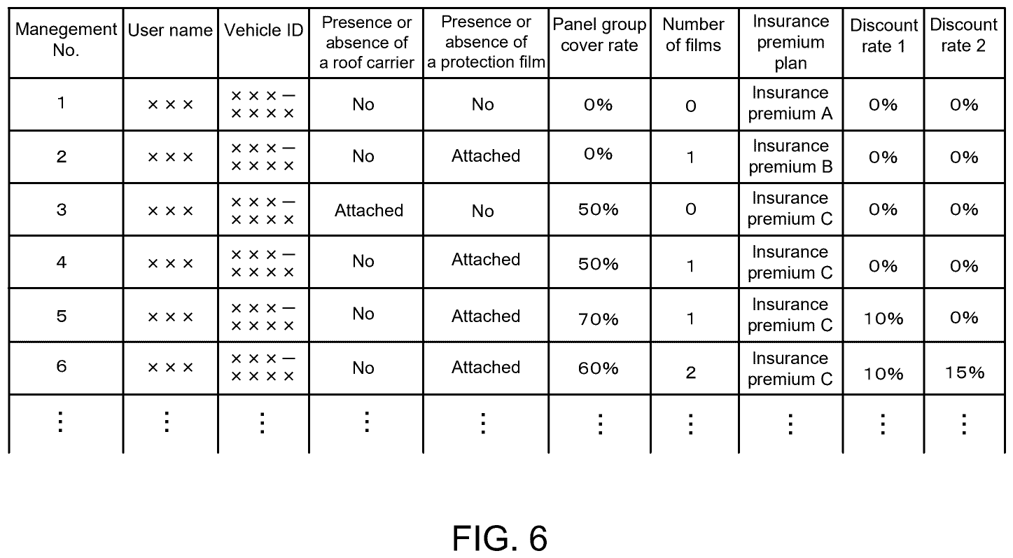

For example, FIG. 6 shows an insurance premium A, an insurance premium B, and an insurance premium C as plans of insurance premiums. As described later, when the panels welded to the skeleton part is covered with the protective component, the insurance premium C, which is the first insurance premium, is calculated. In addition, in a case where only the panels that are not welded to the skeleton part is covered with the protective component, the insurance premium B, which is the second insurance premium, is calculated. Here, the premium C (first premium) is lower (cheaper) than the premium B (second premium).

By adopting the above-described fee system, an incentive of preferentially covering the panels welded to the skeleton part with the protective component is generated. That is, a decrease in market value of the vehicle can be suppressed through the fee system of the insurance premium.

For example, in a vehicle type such as a so-called high wagon, the roof side panels 22 and the roof panels 23 are disposed at high positions that are unseeable to people. That is, in consideration of the external design of the vehicle 20, there is little advantage of covering the roof side panel 22 and the roof panel 23 with a protective component (particularly, the protection film 50). Therefore, in the calculation device according to the present embodiment, an incentive for protecting the roof side panel 22 and the roof panel 23 is given to the user by the fee system of the insurance premium. As a result, a decrease in market value of the vehicle 20 can be suppressed.

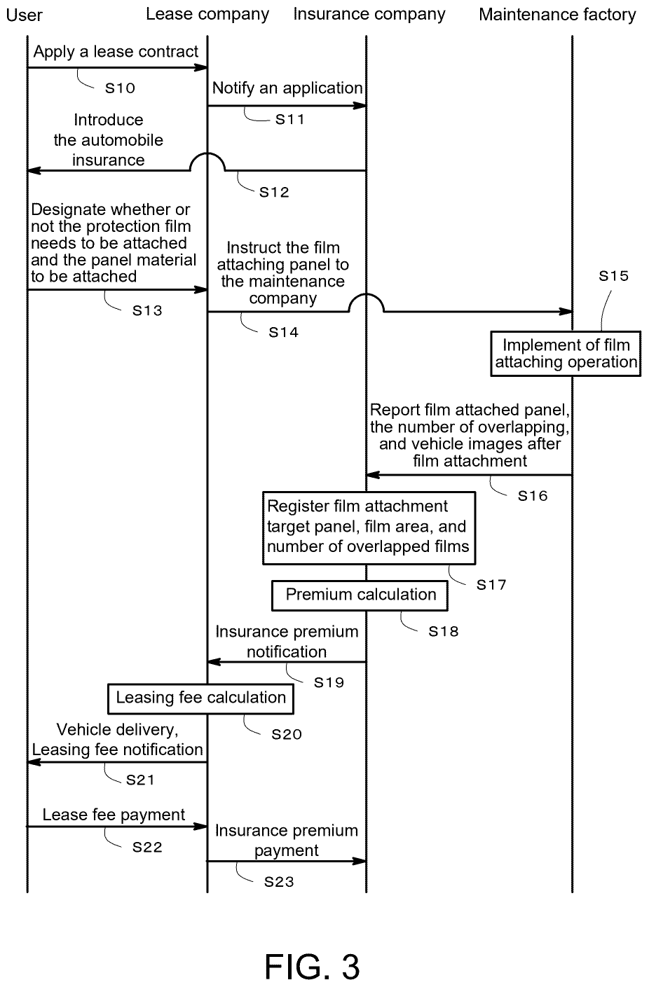

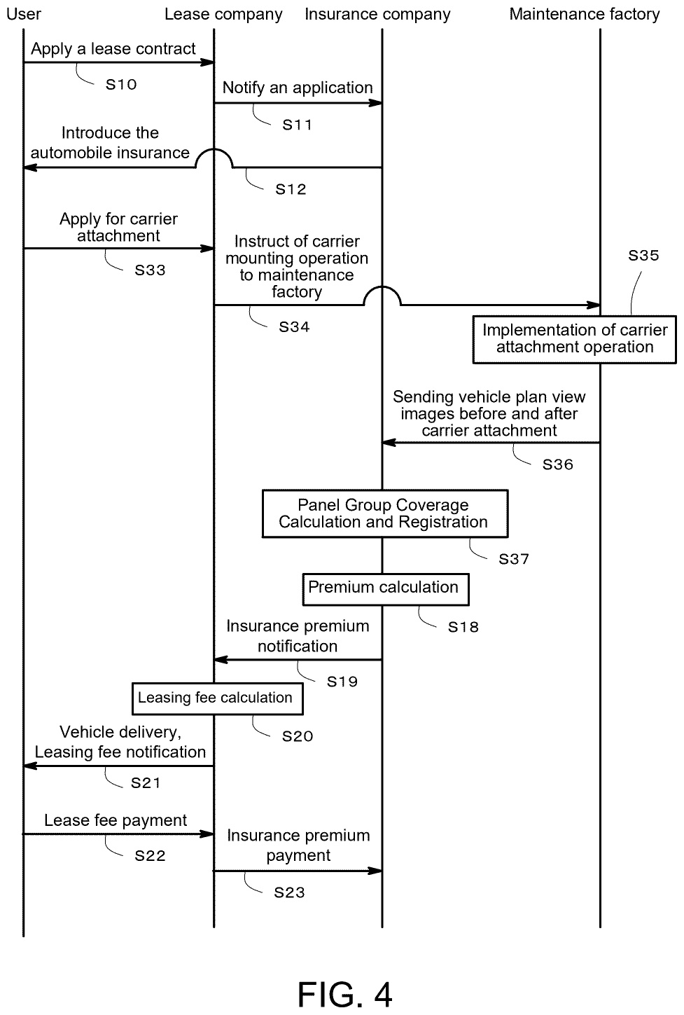

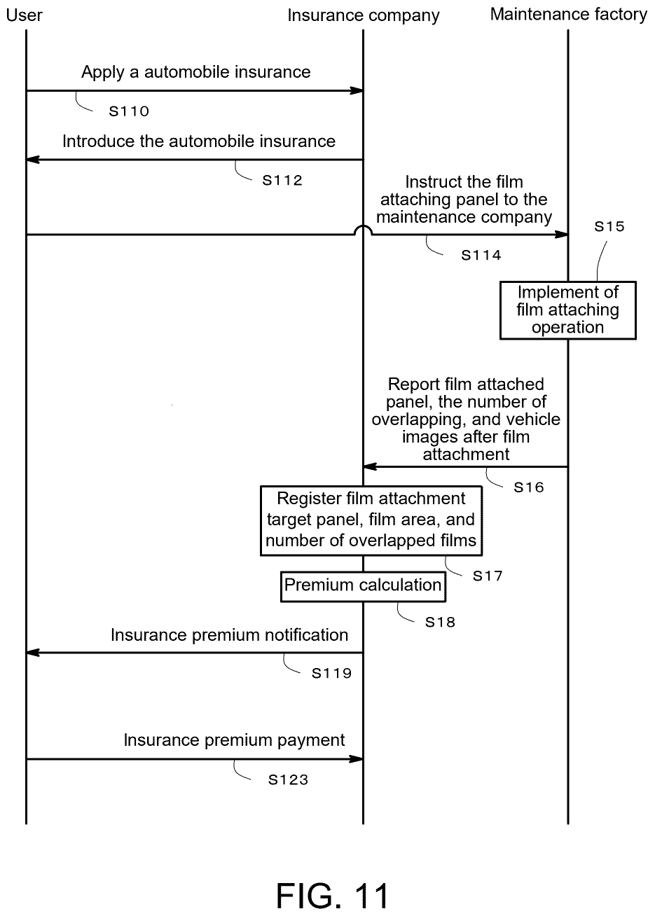

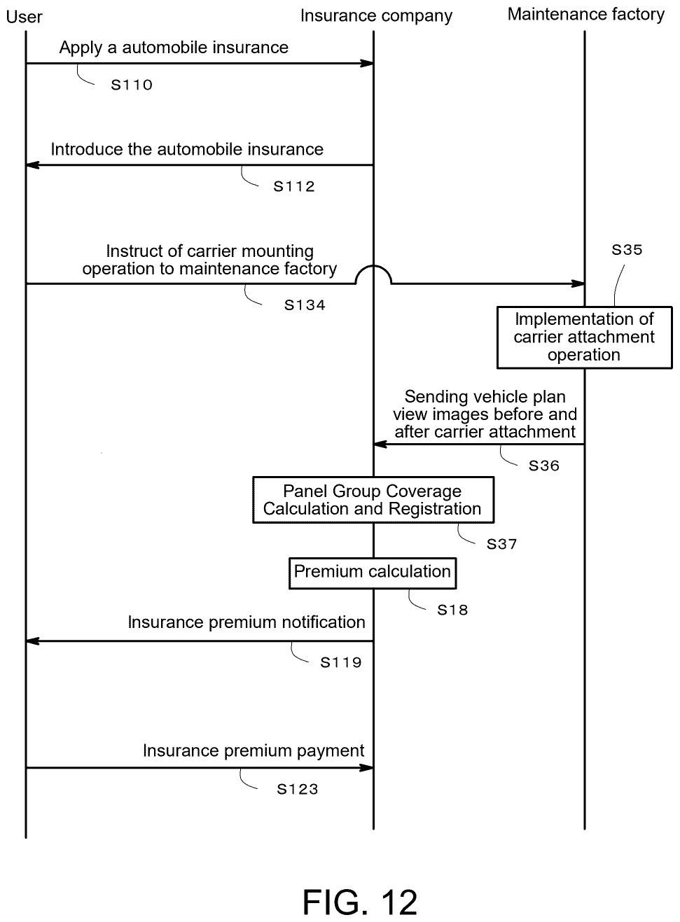

For example, when the vehicle 20 is used by the user by a lease contract as illustrated in FIGS. 3 and 4, the asset value of the vehicle 20 can be maintained for the lease company. Further, as illustrated in FIGS. 11 and 12, the user who is the owner of the vehicle 20 may directly contract with the insurance company. In such a case, the asset value of the vehicle 20 can be maintained for the user.

### 2. Protective Component

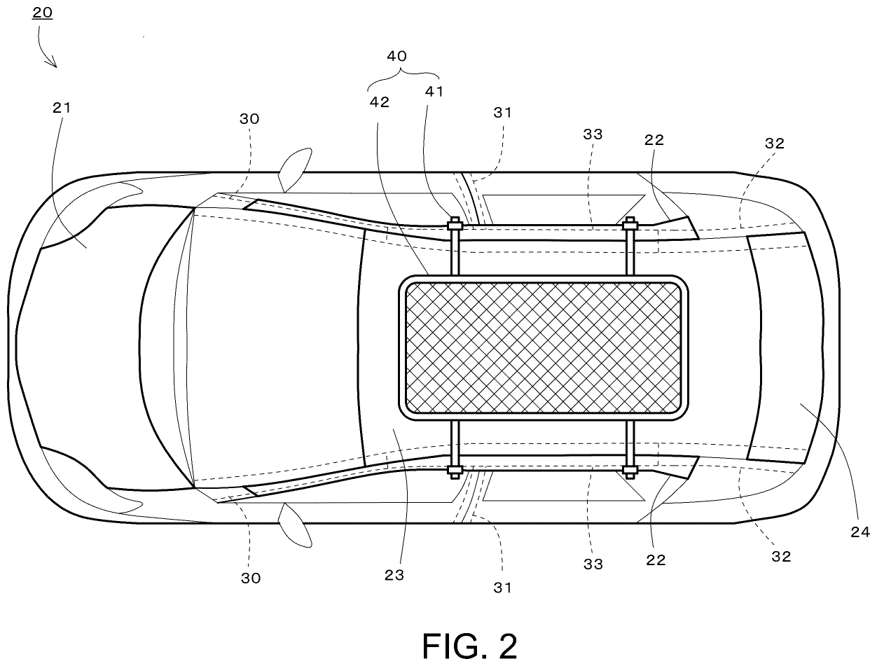

FIG. 1 exemplifies a protection film 50 as a protective component covering the panels. FIG. 2 illustrates a roof carrier 40.

The protection film 50 is a surface protection film attached to the panels. For example, the protection film 50 is a laminate including an adhesive layer, a base material layer, and a topcoat layer. The protection film 50 has scratch resistance. For example, when hails, the protection film 50 receives hail. That is, the protection film 50 functions as a cushion.

The durable life of the protection film 50 is determined. For example, the durable life of the protection film 50 is about 5 years. This durable life may be defined in the period of the lease agreement. That is, the lease contract is concluded in units of 5 years. Alternatively, the durable life of the protection film 50 may not coincide with the period of the lease contract.

FIG. 1 shows an example in which a protection film 50 is attached to the hood panel 21. For example, the protection film 50 is cut in advance so as to conform to the shape of the hood panel 21.

In order to attach the protection film 50 along the three-dimensional curved surface shape of the panel, a high technology is required. Thus, as in step S14 of FIG. 3 to be described later, the protection film 50 is attached in a maintenance factory.

FIG. 2 illustrates a roof carrier 40 as a protective component covering the panels. The roof carrier 40 includes a base carrier 41 and an attachment 42. The roof carrier 40 is installed on the roof panel 23.

The base carrier 41 is connected to a skeleton part of the vehicle. An attachment 42 is attached to the base carrier 41. In FIG. 2, a roof rack is exemplified as the attachment 42. Instead of a roof rack, a roof box may be attached to the base carrier 41 as an attachment 42.

When the roof carrier 40 is installed in the vehicle 20, a part of the roof panel 23 is covered with the attachment 42. The portion of the roof panel 23 covered with the attachment 42 is protected from hail.

### 3. Lease Contract with Vehicle Insurance

For example, the vehicle 20 is lent to the user from a lease company. The fee for use of the lease service includes a vehicle insurance premium. For example, when a user completes a leasing contract with a leasing company, vehicle insurance to contract is introduced by the insurance company.

For example, in a case where the vehicle 20 is damaged due to a natural disaster, the insurance company bears the repair cost. For example, when the panels on the top of the vehicle 20 is damaged by hail, the insurance company bears the replacement cost.

For this vehicle insurance, the user pays an insurance premium every month. As insurance premiums, for example, an insurance premium A, an insurance premium B, and an insurance premium C as illustrated in FIG. 6 are proposed to the user. The premium B and the premium C are lower than the premium A. Further, the premium C is lower than the premium B (A>B>C).

The premium A is applied when a protective component is not attached to the vehicle 20. The premium B and the premium C are applied when a protective component is attached to the vehicle 20. That is, when equipment such that a repair cost burden by the insurance company can be reduced is mounted on the vehicle 20, the insurance premium is reduced.

Here, the group of panels welded to the skeleton parts of the vehicle 20 is hereinafter referred to as a panel group. The roof side panel 22 and the roof panel 23 are included in the panel group. On the other hand, the hood panel 21 and the back door panel 24 are not included in the panel group. When the panels included in the panel group is covered with the protective component, the lowest insurance premium C is applied. If only the panels not included in the panel group is covered with the protective component, the premium B is applied. For example, in the case where the roof carrier 40 (see FIG. 2) is installed on the roof panel 23 as in management No. 3 of FIG. 6, the premium C is applied. When the protection film 50 is attached to the hood panel 21, the insurance premium B is applied as in Management No. 2.

In other words, when the protective component is attached to the panels such that the replacement work in which the repair history is given is required, the insurance premium is the least expensive. As described above, the decrease in the market value of the vehicle 20 can be suppressed through the fee system of the vehicle insurance.

FIG. 3 illustrates a flow of a lease contract when the protection film 50 is attached. The user applies for the lease service to the lease company (S10). The leasing company notifies the insurance company that the leasing service has been applied (S11). In response to this, the insurance company introduces the automobile insurance to the user (S12). Specifically, the insurance company gives the user a description of the contents guaranteed by the vehicle insurance and the insurance premium A-insurance premium C. Note that, in step S12, the insurance company explains to the user that the cost of the protection film 50 and the attachment cost are the user burden.

The user answers to the lease company whether or not the protection film 50 needs to be attached. When the user desires to attach the protection film 50, the panel to be attached is designated by the user (S13). Further, the user may specify the area of the protection film.

When the user desires to attach the protection film 50, the lease company enters the vehicle 20 to be leased into the maintenance company. Further, the leasing company requests the maintenance company to apply the protection film 50 (S14). At the time of this request, the product name of the protection film 50, the area of the protection film 50, the panels to be attached, and the attachment location are instructed from the lease company to the maintenance company.

In the maintenance company, the protection film 50 is attached to the panels of the vehicle 20 according to the request (S15). Although not shown, after the attachment operation, the maintenance company charges the user for the protection film and the work fare. Further, the maintenance company sends a work report to the insurance company (S16). The report includes the name of the panels to which the protection film 50 is attached. In addition, the report includes the number of the overlapped protection films 50. Further, the plan view image of the vehicle 20 after the protection film 50 is attached is included in the work report.

In the insurance company, the items reported from the maintenance company are registered in the database (S17). That is, the name of the panels to which the protection film 50 is attached, the number of overlapped protection films 50, and the plan view image of the vehicle 20 are registered in the database.

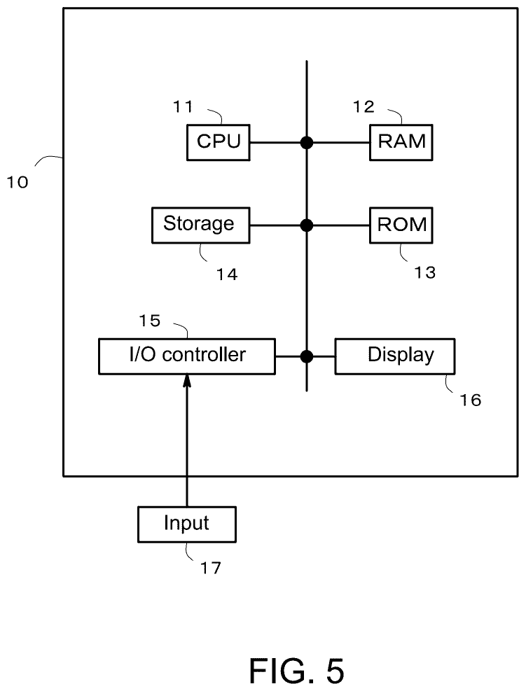

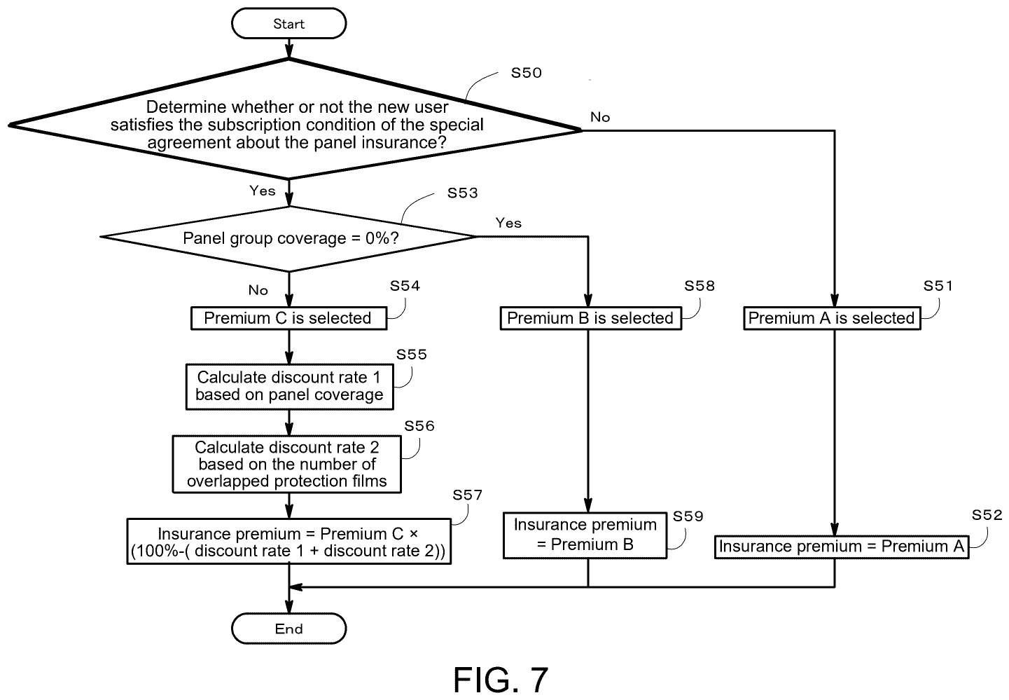

The insurance company is provided with a vehicle insurance premium calculation device 10 (see FIG. 5). The calculation device 10 calculates an insurance premium based on the insurance premium calculation flow (see FIG. 7) described later (S18). The calculated premium is notified to the lease company (S19). The lease company calculates a lease fee (month fee) including the notified insurance premium (S20).

The calculated lease fee is notified to the user. The vehicle 20 is delivered to the user (S21). The user pays a lease fee to the lease company every month (S22). The lease company pays a part of the lease fee to the insurance company (S23).

FIG. 4 illustrates a flow of a lease contract when the roof carrier 40 (see FIG. 2) is attached to the vehicle 20 as a protective component. Steps having the same contents as those of the steps illustrated in FIG. 3 are denoted by the same reference numerals. Further, the explanation of the same steps as those illustrated in FIG. 3 will be omitted as appropriate.

The user is introduced with automobile insurance from an insurance company (S12). In response to this, the user answers to the lease company whether or not the roof carrier 40 needs to be attached (S33). When the user desires to attach the roof carrier 40, the lease company enters the vehicle 20 to be leased into the maintenance company. Further, the lease company requests the maintenance company to attach the roof carrier 40 (S34).

In the maintenance company, the roof carrier 40 is mounted on the roof panel 23 of the vehicle 20 according to the request (S35). Although not shown, after the mounting operation, the maintenance company charges the user with the fee of the roof carrier 40 and the work fare. Further, the maintenance company sends a work report to the insurance company (S36). The report includes a plan view image of the vehicle 20 before the roof carrier 40 is attached. The report further includes a plan view image of the vehicle 20 after the roof carrier 40 is attached.

In the insurance company, the panel group coverage illustrated in FIG. 6 is calculated based on the plan view image of the vehicle 20 (S37). The panel group cover ratio indicates the ratio of the planar view area of the protective component (the roof carrier 40 or the protection film 50) to the sum of the planar view areas of the panels included in the panel group.

For example, the vehicle insurance premium calculation device 10 (see FIG. 5) obtains the total sum ΣSp of the plan view areas of the panels included in the panel group from the plan view image of the vehicle 20 before the roof carrier 40 is attached. For example, the calculation device 10 calculates the planar area of the roof panel 23 and the roof side panel 22 by using an image recognition technique.

Further, the calculation device 10 calculates the plan view area Sc in which the protective component covers the panel group from the plan view image of the vehicle 20 after the roof carrier 40 is attached. Further, the calculation device 10 calculates Sc/ΣSp [%] as the panel group coverage.

Based on the calculated panel group coverage, the calculation device 10 calculates an insurance premium (S18). Details of the calculation flow of the insurance premium will be described later.

### 4. Vehicle Insurance Contract

FIGS. 11 and 12 exemplify a flow at the time of contracting automobile insurance for the vehicle 20 possessed by the user. Note that description of the steps denoted by the same reference numerals as those in FIGS. 3 and 4 will be omitted as appropriate.

The user applies for automobile insurance to the insurance company (S110). In response to this, the insurance company introduces automobile insurance to the user (S112). Specifically, the insurance company gives the user a description of the contents guaranteed by the vehicle insurance and the insurance premium A-insurance premium C. Note that, in step S112, the insurance company explains to the user that the cost of the protection film 50 and the attachment cost are the user burden.

When the user desires to attach the protection film 50, the user enters the vehicle 20 into the maintenance company. Further, the user requests the maintenance company to apply the protection film 50 (S114). At the time of this request, the product name of the protection film 50, the area of the protection film 50, the panels to be attached, and the attachment location are instructed from the user to the maintenance company.

Thereafter, the insurance premium is calculated through steps S15 to S18 as in FIG. 3. The calculated premium is notified to the user (S119). The user pays the insurance premium to the insurance company (S123).

FIG. 12 illustrates a flow of an automobile insurance contract when the roof carrier 40 (see FIG. 2) is attached to the vehicle 20 as a protective component. Steps having the same contents as those of the steps illustrated in FIGS. 4 and 11 are denoted by the same reference numerals.

As in FIG. 11, the user enters the vehicle 20 into the maintenance company through steps S110 and S112. Further, the user instructs the maintenance company to attach the roof carrier 40 (S134).

Thereafter, the insurance premium is calculated through steps S35, S36, S37, and S18 similar to those in FIG. 4. The calculated premium is notified to the user (S119). The user pays the insurance premium to the insurance company (S123).

### 5. Vehicle Insurance Premium Calculation Device

FIG. 5 exemplifies a vehicle insurance premium calculation device 10 according to the present embodiment. The calculation device 10 includes, for example, a computer. The calculation device 10 includes a CPU 11, a RAM 12, a ROM 13, a storage 14, an input/output controller 15, and a display unit 16. The calculation device 10 is connected to the input device 17. The input device 17 is, for example, a keyboard or a mouse.

The CPU 11 is a central processing unit and is also called a processor. The RAM 12 is a volatile storage device that temporarily stores data during work. The ROM 13 is a storage device capable of reading data. The storage 14 is a storage device capable of writing and reading data. The storage 14 includes, for example, a hard disk drive (HDD) and a solid state drive (SSD).

The CPU 11 (processor) executes a program stored in the ROM 13 or the storage 14. Accordingly, the CPU 11 can execute the insurance premium calculation flow illustrated in FIG. 7. In addition, an insurance contract table illustrated in FIG. 6 is generated in the storage 14.

In the insurance contract table, data relating to the subscription status of vehicle insurance is recorded. The items of the insurance contract table include a user name, a vehicle ID, the presence or absence of a protection film, the presence or absence of a roof carrier, a panel group cover rate, the number of films, an insurance premium plan, and a discount rate.

As the vehicle ID, for example, an automobile registration number of the vehicle 20 is recorded. The items of the presence or absence of the protection film and the presence or absence of the roof carrier are input based on the operation reports of step S16 of FIG. 3 and step S36 of FIG. 4. The panel group cover ratio is obtained by the calculation process of step S17 in FIG. 3 and step S37 in FIG. 4. The premium plan and the discount rate are calculated by the premium calculation flow illustrated in FIG. 7.

### 6. Insurance Premium Calculation Flow

The CPU 11 (see FIG. 5) of the calculation device 10 calculates the insurance premium by executing the insurance premium calculation flow exemplified in FIG. 7 for the user newly registered in the insurance contract table. The CPU 11 determines whether or not the new user satisfies the subscription condition of the special agreement about the panel insurance (S50).

In this step (determination process), the presence or absence of a protective member covering the panel member disposed on the top of the vehicle 20 is determined. In this determination process, for example, when user desires to attach the protection film 50 to the vehicle 20 to be leased at the time of joining the vehicle insurance, the subscription condition of the special agreement about the panel insurance is satisfied. In addition, at the time of subscription to vehicle insurance, when user desires to attach the roof carrier 40 to the vehicle 20 to be leased, the subscription condition of the special agreement about the panel insurance is satisfied.

When the new user does not satisfy the subscription condition of the special agreement about the panel insurance, the insurance premium A is selected (S51, S52). As described above, insurance premium A is higher than insurance premium B and insurance premium C.

On the other hand, when the new user satisfies the subscription condition of the special agreement about the panel insurance, the CPU 11 determines whether or not the panels covered by the protective component (the roof carrier 40 or the protection film 50) is included in the panel group (S53). In this step, the CPU 11 determines whether or not the panel group coverage is 0%.

When the panel group coverage is 0%, panels that is not included in the panel group, such as the hood panel 21 (see FIG. 1), is covered with the protective component. In such a case, the calculation device 10 performs calculation processing of applying the insurance premium B to the new user (S58, S59).

On the other hand, when the panel cover rate is not 0%, that is, when the panel cover rate>0%, in such a case that the panels covered by the protective component is included in the panel group, the calculation device 10 performs calculation processing to apply the insurance premium C to the new user (S54).

Here, the content of step S53 may be changed so that the insurance premium C is selected when the panel coverage is a value that substantially achieves the effect of protecting the panels by the protective component. In other words, the insurance premium C may be applied by sufficiently covering the panels included in the panel group with the protective component. For example, in the case of panel coverage>30%, the premium C is applied.

Further, the CPU 11 continues the calculation process. The CPU 11 calculates a discount rate 1 based on the panel cover rate (S55). For example, referring to the row of management No. 5 illustrated in FIG. 6, when the panel coverage exceeds 50%, 10% is applied as the discount rate 1. Referring to the row of management No. 4 illustrated in FIG. 6, when the panel coverage is 50% or less, the discount rate 1 is set to 0%.

Next, as a calculation process, the CPU 11 calculates a discount rate 2 based on the number of overlapped protection films (S56). The protection film 50 can be overlapped on two sheets or three sheets. As the number of the protection films 50 stacked increases, damage to the panels is reduced. For example, referring to the row of management No. 6 illustrated in FIG. 6, when the number of overlapped protection films 50 is two or more, the discount rate 2 is set to 15%.

Next, as a calculation process, the CPU 11 calculates a final insurance premium based on the calculation results of steps S54, S55, and S56 (S57). That is, the insurance premium to be charged to the user every month is obtained from the formula of insurance premium C×(100%−(discount rate 1+discount rate 2)).

As described above, according to the vehicle insurance premium calculation device of the present embodiment, by providing the insurance premium discount service, it is possible to obtain a motivation for covering the panels disposed on the top of the vehicle with the protective component.

### 7. Example of Attachment of Protection Film

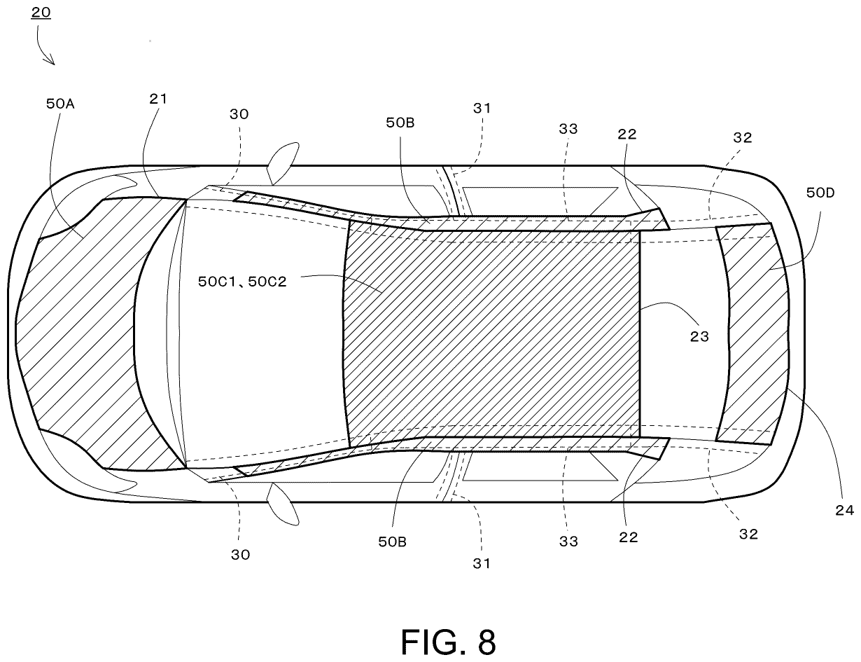

FIG. 8 illustrates the vehicle 20 to which the protection film 50 is attached. In this example, the protection film 50 is attached to all panel members disposed on the top of the vehicle 20. Specifically, the protection film 50A is attached to the entire surface of the hood panel 21. A protection film 50B is attached to the entire surface of the roof side panel 22. Further, a protection film 50D is attached to the entire surface of the back door panel 24.

In addition to the above, two protection films 50C1 and 50C2 are attached to the entire surface of the roof panel 23. That is, the roof panel 23 is protected more firmly than other panels.

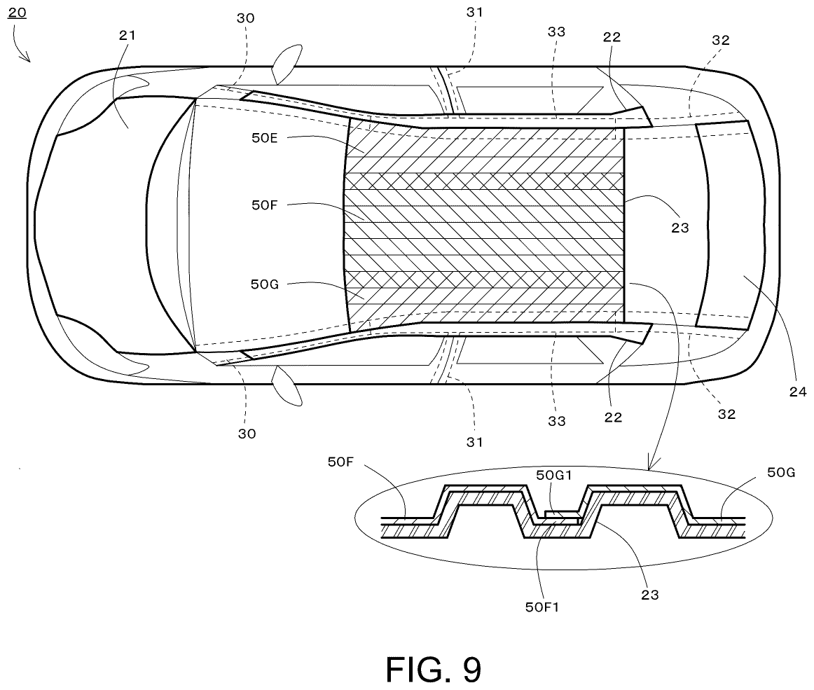

FIG. 9 shows an example in which the protection film 50 is attached only to the roof panel 23. In this example, three protection films 50E to 50G are attached to the roof panel 23.

The protection film 50 is cut away, for example, to coat other vehicles. The remaining portion of the protection film 50 may be attached to the roof panel 23. In such an attachment example, the cost of the film is suppressed to be lower than that in the case where the entire surface of the roof panel 23 is covered with one protection film 50.

For example, the top (exposed surface) of the roof panel 23 may have an uneven structure in order to increase surface rigidity. In such a case, as illustrated in the enlarged cross-sectional view of FIG. 9, the side end portions 50F1 and 50G1 of the protection films 50F and 50G are overlapped in the groove portion of the concave-convex structure. The overlapped side end portions 50F1 and 50G1 are raised. However, since the side end portions 50F1 and 50G1 overlap each other in the groove portion of the roof panel 23, the raised structure of the overlapped films are less likely to be visually recognized.

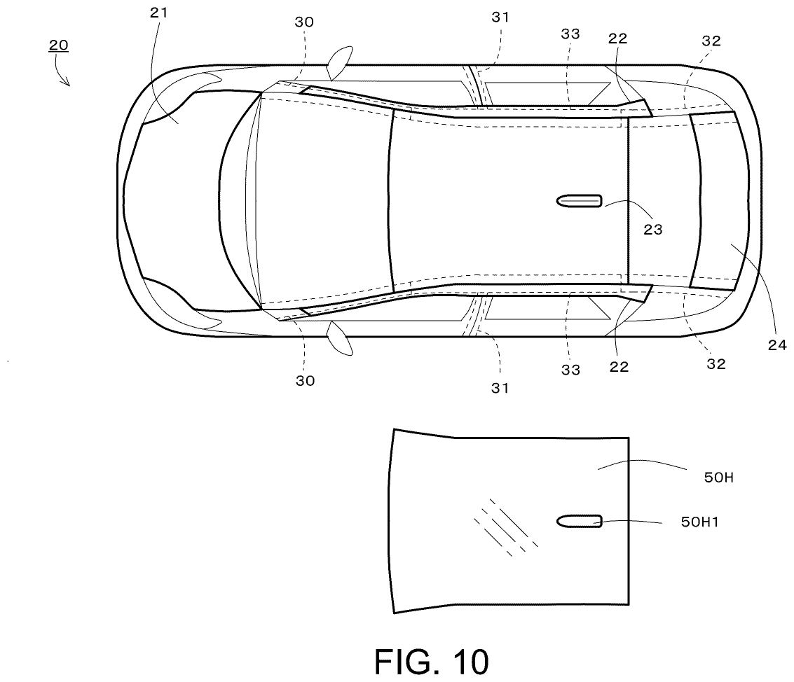

FIG. 10 illustrates a protection film 50H in which a positioning hole 50H1 is drilled. The positioning hole 50H1 corresponds to the shape of the antenna 23A disposed on the roof panel 23. When the protection film 50H is attached, the antenna 23A is inserted into the positioning hole 50H1. Thus, the protection film 50H is accurately positioned on the roof panel 23.

The present disclosure is not limited to the present embodiments described above, and includes all changes and modifications without departing from the technical scope or the essence of the present disclosure defined by the claims.

1. A vehicle insurance premium calculation device comprising a processor, wherein the processor is configured to perform a determination process and a calculation process;
in the determination process, the processor determines the presence or absence of a protective component for covering at least one panel disposed on a top of a vehicle; and
in the calculation process, the processor calculates, when at least one of panels disposed on the top of the vehicle is covered by the protective component, a smaller insurance premium than an insurance premium calculated when none of the panels disposed on the top of the vehicle is covered by the protective component.

2. The vehicle insurance premium calculation device according to claim 1, wherein
in the determining process, the processor determines whether the at least one of panels that is covered by the protective component is contained in a panel group consisting of a plurality of panels welded to a framework component of the vehicle;
in the calculation process, the processor calculates a first insurance premium when the at least one of the panels that is covered by the protective component is contained in the panel group, and calculates a second insurance premium when the at least one of panels that is covered by the protective component is not contained in the panel group, the first insurance premium being lower than the second insurance premium.

3. The vehicle insurance premium calculation device according to claim 2, wherein
in the calculation process, the processor calculates a discount on the first insurance premium, based on a cover ratio being the ratio of an area, in a plan view, of the protective component relative to the sum of areas, in the plan view, of all of the plurality of panels in the panel group.

4. The vehicle insurance premium calculation device according to claim 2, wherein
a protection film is attached as the protective component onto the at least one of panels; and
when the protection film comprises two or more overlapped protection films, the processor calculates, in the calculation process, the discount on the first insurance premium, based on the number of the overlapped protection films.
